(19) United States
(12) Patent Application Publication
(10) Pub. No.: US 2026/0347519 A1
(43) Pub. Date: Nov. 5, 2026

(54) CATALYST SYSTEM BASED ON AN IRON COMPLEX AND USE THEREOF FOR THE POLYMERIZATION OF CONJUGATED DIENES

(71) Applicants: COMPAGNIE GENERALE DES ETABLISSEMENTS MICHELIN, Clermont-Ferrand (FR); CENTRE NATIONAL DE LA RECHERCHE SCIENTIFIQUE, PARIS (FR); ECOLE SUPERIEURE DE CHIMIE PHYSIQUE ELECRONIQUE DE LYON, Villeurbanne Cedex (FR); INSTITUT NATIONAL DES SCIENCES APPLIQUEES DE LYON (INSA LYON), Villeurbanne (FR); UNIVERSITE CLAUDE BERNARD LYON 1, Villeubanne (FR)

(72) Inventors: FLORENT VAULTIER, Clermont-Ferrand (FR); NICOLAS HALL, Clermont-Ferrand (FR); VINCENT MONTEIL, LYON (FR); JEAN RAYNAUD, VILLEURBANNE (FR)

(21) Appl. No.: 19/120,308

(22) PCT Filed: Oct. 11, 2023
(86) PCT No.: PCT/EP2023/078226

§ 371 Date: Apr. 11, 2025

(30) Foreign Application Priority Data
Oct. 14, 2022 (FR) FR2210581

(51) Int. Cl. C08F 136/06

(52) U.S. Cl. CPC C08F 136/06

(57) ABSTRACT

An iron complex is of formula (I): Fe(N(R)₂)₂ (I), in which the R symbols, which are identical or different, represent a hydrogen atom, a substituted or unsubstituted, linear or branched, C₁-C₂₀ aliphatic radical, a substituted or unsubstituted C₃-C₂₀ cycloaliphatic radical, a substituted or unsubstituted C₆-C₂₀ aromatic radical or a silyl radical of formula —Si(R′)₃ in which the R′ symbols, which are identical or different, represent a hydrogen atom, a substituted or unsubstituted, linear or branched, C₁-C₂₀ aliphatic radical, a substituted or unsubstituted C₃-C₂₀ cycloaliphatic radical or a substituted or unsubstituted C₆-C₂₀ aromatic radical The iron complex is used, within a catalytic system, in the polymerization of conjugated dienes, in particular the stereospecific polymerization of 1,3-dienes, especially of butadiene and of isoprene.

### FIELD OF THE INVENTION

The present invention relates to the use of an iron complex in processes for the polymerization of conjugated dienes. In particular, the present invention relates to a catalytic system based on an iron complex and to its process of preparation, and also to its use in the polymerization of conjugated dienes.

### TECHNOLOGICAL BACKGROUND

The stereospecific polymerization of conjugated dienes by means of catalytic systems based on metal compounds is known and widely described in the literature.

From an industrial point of view, the main metals commonly used for the polymerization of butadiene are Ni, Ti, Co and Nd. The recent development of industrial systems for the polymerization of butadiene has concentrated on neodymium-based systems. In point of fact, neodymium is a rare earth metal, the natural resources of which are limited, more than the other metals used in catalytic polymerization. In addition, apart from its use in the industrial polymerization of butadiene, neodymium is also very widely used in the manufacture of permanent magnets, in particular in wind turbines, hard disks, electric motors of hybrid cars, and the like. It has thus become necessary to find economically viable alternatives in order to continue to produce high-quality polybutadiene on an industrial scale.

Aware of this problem, various research groups have proposed in the past to turn to methods for the stereospecific synthesis of polymers of conjugated dienes which are cheaper and more environmentally friendly. Systems for the polymerization of conjugated dienes based on abundant, recyclable and inexpensive metals have thus been developed. Iron is one of these metals.

For example, US20140011971A1 describes the preparation of polyisoprene using a catalytic system based on an iron complex comprising a bidentate amine ligand. Also, the document CN112442092A describes iron complexes comprising a bidentate amine ligand and its use in the stereospecific polymerization of conjugated diene, in particular butadiene.

The paper “Cis-1,4 Specific Polymerization of 1,3-Butadiene Using PNP-pincer Ligated Iron(II) Complexes” by Ryo Tanaka, Kenshi Ikeda, Yuushou Nakayama and Takeshi Shiono in Chemistry Letters, 2019 (48), pp 525-28, describes another type of iron complex for the stereospecific polymerization of butadiene, this one comprising a “pincer” ligand of PNP type.

The catalytic systems based on an iron complex proposed to date rely on chemistries of complex ligands which are often incompatible with industrial use. These iron complexes are in addition generally poorly soluble in the aliphatic solvents of use in the polymerization of conjugated dienes on an industrial scale.

It is a constant concern to find new methods for the stereospecific synthesis of conjugated dienes which have a restricted environmental footprint while remaining economically advantageous for the industrial production of polydienes, in particular of butadiene or isoprene polymers.

Continuing their efforts to search for an industrial polymerization of conjugated dienes which is less expensive and more ethical, the applicant organisations have discovered that the use of a particular iron compound makes it possible to efficiently polymerize conjugated dienes in the aliphatic solvents commonly used on an industrial scale and to obtain stereoregular polymers. This iron complex exhibits the advantage of using an abundant, recyclable and inexpensive metal, an advantage coupled with a simple ligand chemistry with little in the way of a synthesis stage.

### BRIEF DESCRIPTION OF THE INVENTION

A first subject-matter of the invention is the use of an iron complex of formula (I):

Fe(N(R)₂)₂ (I),

in which the R symbols, which are identical or different, represent a hydrogen atom, a substituted or unsubstituted, linear or branched, C₁-C₂₀ aliphatic radical, a substituted or unsubstituted C₃-C₂₀ cycloaliphatic radical, a substituted or unsubstituted C₆-C₂₀ aromatic radical or a silyl radical of formula —Si(R′)₃ in which the R′ symbols, which are identical or different, represent a hydrogen atom, a substituted or unsubstituted, linear or branched, C₁-C₂₀ aliphatic radical, a substituted or unsubstituted C₃-C₂₀ cycloaliphatic radical or a substituted or unsubstituted C₆-C₂₀ aromatic radical, in the polymerization of conjugated dienes.

A second subject-matter of the invention is a catalytic system comprising such an iron complex, a solvent, a cationizing agent and an alkylating agent.

A third subject-matter of the invention is a process for the synthesis of a diene polymer using such a catalytic system.

### DEFINITIONS

In the present description, the following terms have the meanings below, unless otherwise indicated: The expression “Cr-Cy” for a hydrocarbon radical means that said radical comprises from x to y carbon atoms.

The terms “radical” and “group” are equivalent and interchangeable.

The term “aliphatic radical” denotes a saturated or unsaturated, acyclic or cyclic, hydrocarbon radical, with the exclusion of aromatic radicals, preferably comprising in this instance 1 to 20 carbon atoms. The aliphatic radical can be linear or branched. Examples of linear or branched aliphatic radicals include C₁-C₂₀ alkyl groups, C₂-C₂₀ alkenyl groups and C₂-C₂₀ alkynyl groups.

The term “alkyl” denotes a saturated monovalent, linear or branched hydrocarbon radical comprising from 1 to 20 carbon atoms, preferably from 1 to 10 carbon atoms, for example the methyl and ethyl radical and propyl, butyl, pentyl, hexyl, heptyl, octyl, nonyl and decyl radicals.

The term “alkenyl” denotes a monovalent hydrocarbon radical comprising at least one double bond, the said radical being linear or branched and preferably comprising in this instance from 2 to 20 carbon atoms, preferably from 2 to 6 carbon atoms, for example the ethenyl, vinyl, butenyl or 2-propen-1-yl (allyl) radical.

The term “alkynyl” denotes a monovalent hydrocarbon radical comprising at least one triple bond, the said radical being linear or branched and preferably comprising in this instance from 2 to 20 carbon atoms, preferably from 2 to 6 carbon atoms, for example the ethynyl, propynyl or butynyl radical.

The term “cycloaliphatic radical” denotes a saturated or unsaturated, mono- or polycyclic, aliphatic radical preferably comprising in this instance from 3 to 20 atoms. Examples of cycloaliphatic radicals include C₃-C₂₀ cycloalkyl groups and C₃-C₂₀ cycloalkenyl groups.

The term “cycloalkyl” denotes a saturated monocyclic hydrocarbon radical preferably comprising in this instance from 3 to 20 carbon atoms, preferably from 3 to 10 carbon atoms. Examples of cycloalkyl radicals include the cyclopentyl, cyclohexyl or cycloheptyl radical.

The term “cycloalkenyl” denotes a monocyclic hydrocarbon radical comprising at least one double bond and preferably comprising in this instance from 3 to 20 carbon atoms, preferably from 3 to 10 carbon atoms.

The term “aromatic radical” denotes a mono- or polycyclic aromatic radical preferably comprising in this instance from 5 to 20 ring members. Examples of aromatic radicals include aryl groups.

The term “aryl” denotes a mono- or polycyclic aromatic hydrocarbon radical preferably comprising in this instance from 6 to 20 carbon atoms, preferably from 6 to 10 carbon atoms. Examples of aryl radicals include the phenyl radical and the naphthyl radical.

The notation “(halo)” preceding a radical means that the latter comprises or does not comprise a halogen atom. For example, the (halo)aryl radical encompasses the aryl radical and the halogenated aryl radical.

The term “halogen atom” is understood to mean an atom chosen from chlorine, bromine, iodine and fluorine.

### DETAILED DESCRIPTION OF THE INVENTION

A first subject-matter of the invention is the use of an iron complex in the polymerization of conjugated dienes.

### A/ Iron Complex

The iron complex of use for the requirement of the present invention is a compound of formula (I):

Fe(N(R)₂)₂ (I),

in which the R symbols, which are identical or different, represent a hydrogen atom, a substituted or unsubstituted, linear or branched, C₁-C₂₀ aliphatic radical, a substituted or unsubstituted C₃-C₂₀ cycloaliphatic radical, a substituted or unsubstituted C₆-C₂₀ aromatic radical or a substituted or unsubstituted silyl radical of formula —Si(R′)₃ in which the R′ symbols, which are identical or different, represent a hydrogen atom, a substituted or unsubstituted, linear or branched, C₁-C₂₀ aliphatic radical, a substituted or unsubstituted C₃-C₂₀ cycloaliphatic radical or a substituted or unsubstituted C₆-C₂₀ aromatic radical.

Such iron metal compounds are used in particular in WO 2019008279 for their catalytic activity in the hydrosilylation and/or dehydrogenating silylation of organopolysiloxane compounds with a compound comprising at least one hydrosilyl function.

The aliphatic, cycloaliphatic and aromatic radicals defining R and R′ can be substituted by one or more substituents independently chosen from halogen atoms, C₃-C₆ (halo)cycloalkyls or C₆-C₁₄ (halo)aryls.

The cycloaliphatic radical and the aromatic radical defining R and R′ can, in addition or alternatively, be substituted by one or more substituents independently chosen from C₁-C₁₀ (halo)alkyls, C₇-C₁₂ (halo)aralkyls, C₂-C₁₀ (halo)alkenyls and C₂-C₁₀ (halo)alkynyls.

According to certain embodiments, in the formula (I) above, each R represents a silyl radical of formula —Si(R′)₃ in which each R′ represents, independently of one another, a hydrogen atom or a C₁-C₂₀ alkyl radical, preferably a C₁-C₁₀ alkyl radical, for example a methyl, ethyl, n-propyl, isopropyl, n-butyl, sec-butyl, isobutyl or tert-butyl radical.

According to certain embodiments, in the formula (I) above, each R represents a trialkylsilyl radical of formula —Si(R′)₃ in which each R′ represents a C₁-C₄ alkyl radical, for example a methyl radical.

According to certain embodiments, the iron complex of formula (I) is an iron(II) bis[N,N-bis(trialkylsilyl)amide], in particular iron(II) bis[N,N-bis(trimethylsilyl)amide].

### Preparation of the Iron Complex:

The iron complex of formula (I) can be prepared in a known way according to a simple process of reaction of an iron halide, for example iron chloride or bromide, in the presence of THF, with a lithium amide of formula Li—N(SiR₃)₂. Such a process is described, for example, in WO 2013043912A2, or also in the paper by Andersen, R. A.; Faegri, K.; Green, J. C.; Haaland, A.; Lappert, M. F.; Leung, W. P. and Rypdal, K.; Inorg. Chem., 1988, 27 (10), 1782-1786, as regards the synthesis of Fe(N(SiMe₃)₂)₂.

According to the invention, the iron complex of formula (I) is used for the polymerization of conjugated dienes, in particular 1,3-dienes, preferably butadiene, isoprene or their mixtures.

For the requirements of the invention, the iron complex of formula (I) is then advantageously used within a catalytic system.

### B/ Catalytic System

Thus, the present invention also relates to such a catalytic system, which comprises:
an iron complex of formula (I):

Fe(N(R)₂)₂ (I),
a solvent,
a cationizing agent, and
an alkylating agent.

### a) Solvent of the Catalytic System

The solvent of the catalytic system is chosen so that all the other components of the catalytic system are soluble in said solvent.

According to the embodiments, the solvent of the catalytic system is chosen:
from polar aprotic solvents chosen from ethers, amines and their mixtures; or
from non-polar aliphatic solvents, non-polar aromatic solvents and their mixtures.

Thus, according to certain embodiments, the solvent of the catalytic system is an non-polar aliphatic solvent, a non-polar aromatic solvent or a mixture of a non-polar aliphatic solvent and of a non-polar aromatic solvent. By way of example, the solvent of the catalytic system can be cyclohexane, methylcyclohexane, toluene, benzene and their mixtures. Preferably, according to these embodiments, the solvent of the catalytic system is aromatic; more preferentially then, the solvent is toluene. According to these embodiments, the stereospecificity of the catalytic system favours the insertion in the cis-1,4-position of the 1,3-diene monomers and thus the formation of predominantly cis poly-1,3-dienes.

Also, according to other embodiments, the solvent of the catalytic system is a polar aprotic solvent chosen from ethers, amines and their mixtures; preferably then, the solvent of the catalytic system is an ether, more preferentially a tetrahydrofuran (THF) derivative, for example methyltetrahydrofuran. According to these embodiments, the stereospecificity of the catalytic system favours the insertion in the trans-1,4-position of the 1,3-diene monomers and thus the formation of predominantly trans poly-1,3-dienes.

### b) Alkylating Agent

The catalytic system according to the invention also comprises an alkylating agent. The alkylating agent can be any alkylating agent commonly employed for the polymerization of conjugated diene monomers.

More particularly, the alkylating agent can be an organometallic alkylating agent of metals from groups 1, 2, 12 and 13 of the Periodic Table according to the IUPAC (December 2018).

Examples of such alkylating agents include alkylating agents belonging to the group consisting of alkylmagnesiums, alkyllithiums, alkylzincs, alkylaluminiums, Grignard reagents and the mixtures of these constituents.

Alkylating agents belonging to the group of the alkylaluminiums can be represented by the following formula (II): (Ra)_{m′}Al(ORb)_{n′}H_{p′}X_{q′} (II)

in which:
Ra and Rb are identical or different and each represent a hydrocarbon group of 1 to 15 carbon atoms, preferably a hydrocarbon group of 1 to 4 carbon atoms;
X is a halogen atom; and
m′, n′, p′ and q′ are numbers satisfying the following conditions:

0<m′≤3,

0≤n′<3,

0≤p′<3,

0≤q′<3 and

m′+n′+p′+q′=3.

More particularly, the alkylaluminiums of formula (II) can be compounds represented by the following formulae:

(Ra)_{m′}Al(ORb)_{3-m′} i)

in which Ra and Rb are the same or different and each represent a hydrocarbon group of 1 to 15 carbon atoms, preferably a hydrocarbon group of 1 to 4 carbon atoms; and m′ is preferably a number satisfying the condition of 1.5≤m′≤3;

(Ra)_{m′}AlX_{3-m′} ii)

in which Ra is a hydrocarbon group of 1 to 15 carbon atoms, preferably a hydrocarbon group of 1 to 4 carbon atoms; X is a halogen atom; and m′ is preferably a number satisfying the condition of 0<m′<3;

(Ra)ₘAlH_{3-m′} iii)

in which Ra is a hydrocarbon group of 1 to 15 carbon atoms, preferably a hydrocarbon group of 1 to 4 carbon atoms; and m′ is preferably a number satisfying the condition of 2≤m′<3;

(Ra)_{m′}Al(ORb)_{n′}X^{q′} iv)

in which Ra and Rb can be identical or different and each represent a hydrocarbon group of 1 to 15 carbon atoms, preferably a hydrocarbon group of 1 to 4 carbon atoms; X is a halogen atom; and m′, n′ and q′ are numbers satisfying the conditions of 0<m′≤3, 0≤n′<3, 0≤q′<3 and m′+n′+q′=3.

Particular examples of alkylaluminium compounds comprise:
tri-n-alkylaluminiums, such as trimethylaluminium, triethylaluminium, tri-n-butylaluminium, tripropylaluminium, tripentylaluminium, trihexylaluminium, trioctylaluminium and tridecylaluminium;
branched-chain trialkylaluminiums, such as triisopropylaluminium, triisobutylaluminium, tri-sec-butylaluminium, tri-tert-butylaluminium, tri-2-methylbutylaluminium, tri-3-methylbutylaluminium, trineopentylaluminium, tri-2-methylpentylaluminium, tri-3-methylpentylaluminium, tri-4-methylpentylaluminium, tri-2-methylhexylaluminium, tri-3-methylhexylaluminium and tri-2-ethylhexylaluminium;
tricycloalkylaluminiums, such as tricyclohexylaluminium and tricyclooctylaluminium;
triarylaluminiums, such as triphenylaluminium and tritolylaluminium;
trialkenylaluminiums represented by the formula (i-C₄H₉)ₐAl_{b}(C₅H₁₀)_{c} (where a, b and c are positive numbers and c≥2×), such as isoprenylaluminium;
alkylaluminium alkoxides, such as isobutylaluminium methoxide, isobutylaluminium ethoxide and isobutylaluminium isopropoxide;
dialkylaluminium alkoxides, such as dimethylaluminium methoxide, diethylaluminium ethoxide and dibutylaluminium butoxide;
alkylaluminium sesquialkoxides, such as ethylaluminium sesquiethoxide and butylaluminium sesquibutoxide;
partially alkoxylated alkylaluminiums having a mean composition represented by Ra_{2.5}Al(ORb)_{0.5}, also known as aluminoxanes, for example methylaluminoxane (MAO), ethylaluminoxane, isobutylaluminoxane and triisobutylaluminoxane;
dialkylaluminium aryloxides, such as diethylaluminium phenoxide, diethylaluminium (2,6-di-t-butyl-4-methylphenoxide), ethylaluminium bis(2,6-di-t-butyl-4-methylphenoxide), diisobutylaluminium (2,6-di-t-butyl-4-methylphenoxide) and isobutylaluminium bis(2,6-di-t-butyl-4-methylphenoxide);
dialkylaluminium halides, such as dimethylaluminium chloride, diethylaluminium chloride, dibutylaluminium chloride, diethylaluminium bromide and diisobutylaluminium chloride;
alkylaluminium sesquihalides, such as ethylaluminium sesquichloride, butylaluminium sesquichloride and ethylaluminium sesquibromide;
partially halogenated alkylaluminiums, such as ethylaluminium dichloride, propylaluminium dichloride and butylaluminium dibromide;
dialkylaluminium hydrides, such as diethylaluminium hydride and diisobutylaluminium hydride;
partially hydrogenated alkylaluminiums, for example alkylaluminium dihydrides, such as ethylaluminium dihydride and propylaluminium dihydride;
   and
partially alkoxylated and halogenated alkylaluminiums, such as ethylaluminium ethoxychloride, butylaluminium butoxychloride and ethylaluminium ethoxybromide.

Alkylating agents belonging to the group of the alkylmagnesiums, alkylzincs or alkylcadmiums (group 2 or group 12) can be represented by the following formula: RaRbM, in which Ra and Rb can be identical or different and each represent a hydrocarbon group of 1 to 15 carbon atoms, preferably a hydrocarbon group of 1 to 4 carbon atoms; and M is Mg, Zn or Cd.

According to certain embodiments, the alkylating agent is an alkylaluminium of formula (II) as defined above. Preferred alkylaluminium examples include:
aluminoxanes, such as methylaluminoxane (MAO), ethylaluminoxane, isobutylaluminoxane and triisobutylaluminoxane;
trialkylaluminiums of formula Al(C₁-C₁₀-alkyl)₃, such as trimethylaluminium, triethylaluminium, tri-n-propylaluminium, triisopropylaluminium, tri-n-butylaluminium, triisobutylaluminium (TiBA), tri-t-butylaluminium, tri-n-pentylaluminium, trineopentylaluminium, tri-n-hexylaluminium, tricyclohexylaluminium and tri-n-octylaluminium, preferably triisobutylaluminium;
dialkylaluminium hydrides of formula Al(C₁-C₁₀-alkyl)₂H, such as diethylaluminium hydride (HDiBA), diisopropylaluminium hydride, di-n-propylaluminium hydride, diisobutylaluminium hydride, di-n-butylaluminium hydride and di-n-octylaluminium hydride, preferably diisobutylaluminium hydride;
alkylaluminium monohalides, such as diethylaluminium chloride (DEAC).

According to some embodiments, the alkylating agent is a trialkylaluminium of formula Al(C₁-C₁₀-alkyl)₃, such as trimethylaluminium, triethylaluminium, tri-n-propylaluminium, triisopropylaluminium, tri-n-butylaluminium, triisobutylaluminium (TiBA), tri-t-butylaluminium, tri-n-pentylaluminium, trineopentylaluminium, tri-n-hexylaluminium, tricyclohexylaluminium and tri-n-octylaluminium, preferably triisobutylaluminium.

According to certain embodiments, the alkylating agent is a dialkylaluminium hydride of formula Al(C₁-C₁₀-alkyl)₂H, such as diethylaluminium hydride, diisopropylaluminium hydride, di-n-propylaluminium hydride, diisobutylaluminium hydride, di-n-butylaluminium hydride and di-n-octylaluminium hydride, preferably diisobutylaluminium hydride.

The abovementioned alkylating agents can be used alone or as a mixture of two or more.

According to certain embodiments, the (alkylating agent)/(iron complex) molar ratio is preferably greater than or equal to 5/1.

A person skilled in the art will understand that there is no maximum limit to the range of values of this molar ratio. This is because there is no maximum, even preferential, value for this (alkylating agent)/(iron complex) molar ratio which is imposed by a deactivation of the catalytic system in the processes for the polymerization of conjugated dienes.

### c) Cationizing Agent

The catalytic system according to the invention also comprises a cationizing agent. The cationizing agent can be any cationizing agent commonly employed for the polymerization of olefins.

According to certain embodiments, the co-catalyst can be a cationizing agent of the following formula (III): [Q]⁺[B(Ri)₄]⁻ (III),

in which:
[Q]⁺ is a proton, a carbonium cation or one of its substituted derivatives (primary, secondary or tertiary carbocation), an ammonium cation or one of its substituted derivatives (primary, secondary, tertiary or quaternary ammonium), an oxonium cation or one of its substituted derivatives, a phosphonium cation, a cycloheptyltrienyl cation, a metallocenium cation of a transition metal, such as a ferrocenium cation, or the like;
B is the symbol for boron;
each Ri represents, independently of one another, a linear or branched C₁-C₂₀ aliphatic radical which is substituted or unsubstituted, a C₃-C₂₀ cycloaliphatic radical which is substituted or unsubstituted or a C₆-C₂₀ aromatic radical which is substituted or unsubstituted.

In this definition, the linear or branched aliphatic radical, the cycloaliphatic radical and the C₆-C₂₀ aromatic radical can be substituted by one or more substituents independently chosen from halogen atoms, C₁-C₅ alkyl groups or C₁-C₅ perfluoroalkyl groups.

According to certain embodiments, Ri represents an aryl group which can be substituted by one or more substituents independently chosen from halogen atoms, C₁-C₅ alkyl groups or C₁-C₅ perfluoroalkylated groups.

According to certain embodiments, Ri independently represents a substituted or unsubstituted phenyl, tolyl, mesityl or xylyl group, more particularly a pentafluorophenyl group.

According to some embodiments, the four Ri groups are identical. According to some embodiments, the four Ri groups are pentafluorophenyl groups.

Examples of [B(Ri)₄]⁻ anion include the alkyltris(pentafluorophenyl)borate, tetrakis(pentafluorophenyl)borate and tetrakis[3,5-bis(trifluoromethyl)phenyl]borate anion.

Examples of carbonium cations include, in a non-limiting way, trisubstituted carbonium cations, such as the triphenylcarbonium cation, the tri(methylphenyl)carbonium cation and the tri(dimethylphenyl)carbonium cation.

Examples of ammonium cations include, in a non-limiting way, primary, secondary and tertiary ammonium cations. Examples of secondary ammonium cations include dialkylammonium and diarylammonium cations, for example the dimethylammonium cation, the diethylammonium cation, the di(isopropyl)ammonium cation, the dicyclohexylammonium cation and the diphenylammonium cation. Examples of ternary ammonium cations include trialkylammoniums, for example the trimethylammonium cation, the triethylammonium cation, the tripropylammonium cation and the tributylammonium cation (in particular the tri(n-butyl)ammonium cation). Examples of ammonium cations also include anilinium cations and their derivatives, such as the anilinium cation, N-alkylanilinium and N,N-dialkylanilinium cations, such as the N-methylanilinium cation, the N,N-dimethylanilinium cation, the N,N-diethylanilinium cation, the N,N,2,4,6-pentamethylanilinium cation, the p-bromo-N,N-dimethylanilinium cation and the p-nitro-N,N-dimethylanilinium cation.

Examples of phosphonium cations include, in a non-limiting way, triarylphosphonium cations, such as the triphenylphosphonium cation, the tri(methylphenyl)phosphonium cation and the tri(dimethylphenyl)phosphonium cation.

According to certain embodiments, the [Q]⁺ cation is a carbonium cation or an ammonium cation as are described above; preferably, [Q]⁺ is the triphenylcarbonium cation, the N,N-dimethylanilinium cation or the N,N-diethylanilinium cation.

According to certain embodiments, the cationizing agent can thus be a trialkyl-substituted ammonium salt, an N,N-dialkylanilinium salt, a dialkylammonium salt or a trisubstituted carbonium salt.

Examples of cationizing agent of formula (III) include triethylammonium tetra(phenyl)borate, tripropylammonium tetra(phenyl)borate, tri(n-butyl)ammonium tetra(phenyl)borate, trimethylammonium tetra(p-tolyl)borate, trimethylammonium tetra(o-tolyl)borate, tri(n-butyl)ammonium tetrakis(pentafluorophenyl)borate, tripropylammonium tetrakis(o,p-dimethylphenyl)borate, tri(n-butyl)ammonium tetrakis(m,m-dimethylphenyl)borate, tri(n-butyl)ammonium tetrakis(p-trifluoromethylphenyl)borate, tri(n-butyl)ammonium tetrakis(3,5-ditrifluoromethylphenyl)borate, tri(n-butyl)ammonium tetra(o-tolyl)borate, N,N-dimethylanilinum tetra(phenyl)borate, N,N-dimethylanilinium tetrakis[3,5-bis(trifluoromethyl)phenyl]borate, N,N-diethylanilinium tetra(phenyl)borate, N,N,2,4,6-pentamethylanilinium tetra(phenyl)borate, di(1-propyl)ammonium tetrakis(pentafluorophenyl)borate, dicyclohexylammonium tetra(phenyl)borate, triphenylcarbonium tetrakis(pentafluorophenyl)borate, triphenylcarbonium tetrakis[3,5-bis(trifluoromethyl)phenyl]borate, N,N-dimethylanilinium tetrakis(pentafluorophenyl)borate, ferrocenium tetrakis(pentafluorophenyl)borate, triphenylcarbenium pentaphenylcyclopentadienyl and N,N-diethylanilinium pentaphenylcyclopentadienyl.

The cationizing agent is preferably a trialkyl-substituted ammonium salt, an N,N-dialkylanilinium salt, a dialkylammonium salt or a trisubstituted carbonium salt; preferably, the cationizing agent is dimethylanilinium tetrakis(pentafluorophenyl)borate or trityl tetrakis(pentafluorophenyl)borate.

The abovementioned cationizing agents can be used alone or as a mixture of two or more.

According to certain embodiments, the (cationizing agent)/(iron complex) molar ratio is preferably less than or equal to 2/1; more preferentially, this molar ratio is within a range of values extending from 1/1 to 2/1.

### C/ Preparation of the Catalytic System

The process for the preparation of the catalytic system described above also forms the subject-matter of the invention.

### a) Pre-Mixing

The constituents of the catalytic system can be premixed before being brought into contact with the monomer(s) to be polymerized. The constituents of the catalytic system are mixed by introducing the iron complex and the cationizing agent into the solvent of the catalytic system. This mixture is subsequently brought into contact with the alkylating agent over a time of between 0 and 120 minutes, at a temperature ranging from 10 °C to 60 °C, generally at ambient temperature (in the vicinity of 23 °C), so as to obtain a premixed catalyst. The premixed catalyst thus obtained is subsequently brought into contact with the monomer(s) to be polymerized, optionally in solution in the polymerization solvent.

### b) Preparation In Situ in Two Stages

The alkylating agent can, in a first step, be mixed with the monomers to be polymerized. The iron complex of formula (I), premixed with the cationizing agent in the solvent of the catalytic system over a time of between 0 and 120 minutes, at a temperature ranging from 10 °C to 60 °C, generally at ambient temperature (in the vicinity of 23 °C), is subsequently added in order to carry out the polymerization reaction.

### c) Preparation In Situ

In a first step, a solution of the iron complex of formula (I) and a solution of the cationizing agent can be added at the same time or successively to the monomers to be polymerized. In a second step, a solution of the alkylating agent is added to the medium. The solvents of the solutions of each component of the catalytic system can be identical or different and chosen from the solvents of the catalytic system which are defined above.

### D/ Polymerization

The catalytic system of the present invention can be employed in processes for the polymerization of conjugated dienes. The monomers to be polymerized can then be brought into contact with the catalytic system in accordance with the invention.

The monomers to be polymerized are chosen from the group of monomers consisting of conjugated dienes.

According to certain embodiments, the conjugated dienes used as monomers to be polymerized are preferably 1,3-dienes having from 4 to 15 carbon atoms. This is because the use of the catalytic system according to the invention makes it possible to synthesize stereospecific polymers of 1,3-dienes, promoting the cis-1,4- or trans-1,4- insertion of the monomers as a function of the nature of the solvent of the catalytic system.

Suitable as 1,3-diene monomers are in particular the 1,3-dienes having from 4 to 12 carbon atoms, such as, for example, butadiene, isoprene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, phenyl-1,3-butadiene, 1,3-pentadiene, and the like.

Also suitable as 1,3-diene monomers are linear terpenes, such as in particular linear monoterpenes (C₁₀H₁₆), for example myrcene, linear sesquiterpenes (C₁₅H₂₄), for example farnesene, and the like.

According to certain embodiments of the invention, the conjugated diene monomer to be polymerized is butadiene or isoprene.

According to certain embodiments of the invention, the polymerization stage of the process is a stage of homopolymerization of a conjugated diene monomer in the presence of a catalytic system as described above.

According to certain embodiments of the invention, the polymerization stage of the process is a stage of copolymerization of at least one conjugated diene monomer in the presence of a catalytic system as described above. The conjugated diene monomer is then copolymerized with at least one other monomer. Suitable as one other monomer is, for example, a 1,3-diene monomer having 4 to 15 carbon atoms as defined above, other than the first 1,3-diene monomer.

The polymerization stage can be carried out in a known way, continuously or batchwise, in bulk or in solution, generally and in a known way at a temperature of preferably at least 40 °C and preferably of at most 120 °C, more preferentially of at most 100 °C.

The polymerization stage can be carried out in an organic solvent conventionally used for the polymerization of diene monomers. According to the invention, the term “organic solvent” is understood to mean an inert hydrocarbon solvent which can, for example, be an aliphatic or alicyclic hydrocarbon, such as pentane, hexane, heptane, isooctane, cyclohexane or methylcyclohexane, or an aromatic hydrocarbon, such as benzene, toluene or xylene, or mixtures of these solvents. It should be noted that non-aromatic solvents are particularly preferred. This is all the more so since the iron complex of formula (I) of use for the requirement of the invention is soluble in aliphatic and alicyclic solvents.

The catalytic system as described above according to all its embodiments is used for polymerization in a reaction medium comprising the monomers to be polymerized and, if appropriate, the polymerization solvent.

According to certain embodiments of the invention, the polymerization stage of the process is preceded by a stage of neutralization of the impurities of the reaction medium. In the context of the invention, this stage can be carried out by addition of a predetermined amount of an organoaluminium compound of formula (II), independently of the introduction of the catalytic system used for the polymerization reaction. This organoaluminium compound can be identical to or different from the organoaluminium compound used as alkylating agent of the catalytic system.

It should be noted that the addition of this organoaluminium compound makes it possible to be rid of the impurities present in the polymerization medium originating from the monomers or from the polymerization solvent, and not to penalize the activity of the catalytic system, so as to minimize the dispersion of the characteristics of the elastomer obtained, in particular of the molecular weights.

A person skilled in the art will understand that, when such a compound is added to the polymerization medium, it is added at least in amounts which depend on the degree of purity of the components of the polymerization medium, composed in particular of the solvent, if appropriate, and of the monomers.

A better understanding of the abovementioned characteristics of the present invention, and also others, will be obtained on reading the following description of several implementational examples of the present invention, given by way of indication and without limitation.

### Examples

Definitions of the abbreviations:
THF=tetrahydrofuran
Me=methyl
TBAr^{F}=trityl tetrakis(pentafIuorophenyl)borate
ABAr^{F}=N,N-dimethylanilinium tetrakis(pentafluorophenyl)borate
MCH=methylcyclohexane
TiBA=triisobutylaluminium
DiBAH=diisobutylaluminium hydride
TEA=triethylaluminium
DiBHT=2,6-di-tert-butyl-4-methylphenol

### Measurements and Tests Used

The yield:

The yield of the polymerization (denoted “η pol (%)”) is calculated via the ratio of the weight of the polymer isolated at the end of the reaction to the weight of monomers introduced into the reactor.

$$η = \frac{{w}_{polymer}}{{w}_{monomers}} \qquad [ Math 1 ]$$

wₘₒₙₒₘₑᵣₛ, which represents the weight of monomers introduced into the reactor,
w_{polymer}, which represents the weight of polymer obtained.

### High Resolution NMR Spectroscopy

The microstructure of the elastomers is characterized by the high resolution NMR spectroscopy technique.

High resolution NMR spectroscopy of the polymers was carried out on a Bruker 400 Avance III spectrometer operating at 400 MHz equipped with a BBFO 5 mm probe for proton and on a Bruker 400 Avance II spectrometer operating at 400 MHz equipped with a PSEX 13C 10 mm probe for carbon. The acquisitions were made in a mixture of tetrachloroethylene (TCE) and of deuterated chloroform (CDCl₃) (2/1 v/v) at 298 K or in chloroform. The samples were analysed at a concentration of 1% by weight for proton and 5% by weight for carbon. The chemical shifts are given in ppm, relative to the proton signal of deuterated chloroform at 7.26 ppm and to the carbon signal of TCE fixed at 120.65 ppm.

### Measurement of the Molar Mass of the Samples

The SEC (Size Exclusion Chromatography) technique makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standard products and the polydispersity index (D=Mw/Mn) can be calculated.

The size exclusion chromatography analyses were carried out using a Viscotek device (Malvern Instruments) equipped with three columns (SDVB, 5 μm, 300×7.5 mm, from Polymer Standard Service), with a guard column and with three detectors (differential refractometer, differential viscometer and light scattering). 1 ml of a sample solution with a concentration of 5 mg·ml⁻¹ in THF was filtered through a 0.45 μm PTFE membrane. 100 μl of this solution were eluted in THF using a flow rate of 0.8 ml·min⁻¹ at a temperature of 35 °C. OmniSEC software was used for the acquisition and the analysis of the data. The number-average molar masses (Mn) and weight-average molar masses (Mw) of the polymers and also their dispersity (Ð) were calculated using a calibration curve from polystyrene standards (Mp: 1306 to 2 520 000 g·mol⁻¹) from Polymer Standard Service (Mainz).

### 1. Synthesis of the Iron(II) Bisamide Compound:

Iron bis(trimethylsilyl)amide of formula Fe(N(SiMe₃)2)₂ is synthesized according to the procedure described by Andersen, R. A.; Faegri, K.; Green, J. C.; Haaland, A.; Lappert, M. F.; Leung, W. P. and Rypdal, K.; Inorg. Chem., 1988, 27 (10), 1782-1786.

In the forms of synthesis which follow, the equivalents are expressed as the molar ratio of the given reactant to the iron(II) bisamide compound prepared.

### 2. Activation of the Iron Complex and Process for the Polymerization of Butadiene:

Iron(II) bis[N,N-bis(trimethylsilyl)amide]stored in a glove box is weighed (40 mg, 0.108 mmol) into a Schlenk tube. The cationizing agent: trityl tetrakis(pentafluorophenyl)borate (TBAr^{F}), or N,N-dimethylanilinium tetrakis(pentafluorophenyl)borate (ABAr^{F}), if appropriate, is added in the proportions appearing in Table 1 (for example, per 1 eq., i.e. 0.108 mmol: 99.6 mg TBAr^{F} and 86.5 mg ABAr^{F}). A volume of a dry solvent, such as are indicated in Table 1, is added.

Independently, 0.81 ml of a solution of alkylaluminium (triisobutylaluminium, 1.33 M, 10 eq., or diisobutylaluminium hydride, 1.51 M, 10 eq.) in methylcyclohexane (MCH) is mixed with 100 ml of MCH. This mixture is introduced into an inerted reactor. The mixture is vigorously stirred for 10 min. The reactor is subsequently placed under reduced pressure using a vane pump before adding 30 ml of butadiene (361.84 mmol, 3350 eq.) which are condensed beforehand in a funnel after passing through an alumina trap, then evaporated to the reactor. Once the introduction of the monomer has been completed, the reactor is heated to 60 °C.

The solution of iron complex and of cationizing agent, pre-activated after stirring for 2 hours, is introduced into the reactor. Once the catalyst has been introduced, the polymerization lasts from 1 to 4 hours at 60 °C.

At the end of the reaction, the reaction medium is precipitated from a solution of DiBHT in methanol. The polymer is subsequently dried and stored at 4 °C.

The summary of the tests and the analysis of the polybutadienes obtained are given in Table 1.

TABLE 1

| | | | Volume of | | | | | | | |
|---|---|---|---|---|---|---|---|---|---|---|
| | | | solvent | | | | | | | |
| | Cationizing | | of the | | | | | | | |
| | agent/iron | Catalytic | catalytic | | | η | | | Mw | |
| Cationizing | complex | system | system | Alkylating | rt | pol | cis/trans | | (kg · mol − | |
| agent | molar ratio | solvent | (ml) | agent | (h) | (%) | ratio | %1,2 | 1 PS eq.) | Ð |
| TBAr^{F} | 1.1 | toluene | 40 | TiBA | 4 | 35 | 84/16 | 5.5 | 137.8 | 2.6 |
| TBAr^{F} | 1.1 | toluene | 20 | TiBA | 1 | 27 | 86/16 | 5.2 | 109.8 | 2.7 |
| TBAr^{F} | 1.0 | toluene | 10 | TiBA | 1 | 34 | 86/14 | 5.0 | 115.1 | 2.5 |
| TBAr^{F} | 2.5 | toluene | 15 | TiBA | 4 | 20 | 86/14 | 6.2 | 63.5 | 3.0 |
| TBAr^{F} | 1.1 | toluene | 15 | HDiBA | 1 | 26 | 88/12 | 5.9 | 87.2 | 2.3 |
| ABAr^{F} | 1.0 | diethyl | 10 | TiBA | 1 | 54 | 29/71 | 9.5 | 61.5 | 2.2 |
| | | ether | | | | | | | | |
| TBAr^{F} | 1.0 | MeTHF | 10 | TiBA | 1 | 23 | 3/97 | 5.2 | nd* | nd* |

[Al]/[Fe] molar ratio = 10;
Monomer M = butadiene, 30 ml, 361 mmol;
[M]/[Fe] molar ratio = 3350;
Cationizing agent = [CPh₃][B(C₆F₅)₄] (TBAr^{F}) or [HNPhMe₂][B(C₆F₅)₄] (ABAr^{F});
Polymerization temperature = 60 °C
η pol = yield of the polymerization
rt = reaction time
nd* = not defined, the polymer cannot be dissolved for the measurement

### 3. Activation of the Iron Complex and Process for the Polymerization of Isoprene:

Iron(II) bis[N,N-bis(trimethylsilyl)amide]stored in a glove box is weighed (20 mg, 0.054 mmol) into a Schlenk tube, it is dissolved in MCH (25 ml); likewise, 1 equivalent of TBAr^{F} (50 mg, 0.054 mmol) is dissolved in toluene (7 ml). Both solutions are added to 27 ml of isoprene (18.4 g, 5000 eq.). After a few seconds, an alkylaluminium solution is added (TiBA, 0.59 ml, 0.91 M, 10 eq., or TEA, 0.54 ml, 1 M, 10 eq.). The mixture is subsequently stirred up to the temperature indicated in Table 2; the reaction lasts 4 hours.

At the end of the reaction, the reaction medium is precipitated from a solution of DiBHT in methanol. The polymer is subsequently dried and stored at 4 °C.

TABLE 2

| | | | | | | Mw | |
|---|---|---|---|---|---|---|---|
| | T °C | η | Microstructure | | | (kg · mol⁻¹ | |
| Al | poly. | (%) | cis-1,4- | trans-1,4- | 3,4 | PS eq.) | Ð |
| TiBA | 35 | 11.5 | 68 | 8 | 24 | 23.2 | 2.0 |
| TiBA | 60 | 25.9 | 66 | 7 | 27 | 13.0 | 2.1 |
| TEA | 25 | 9.8 | 66 | 8 | 26 | 27.3 | 1.7 |
| TEA | 60 | 11.0 | 70 | 6 | 24 | 18.7 | 2.0 |

1.-15. (canceled)

16. A catalytic system for polymerization of conjugated dienes, the catalytic system comprising:
an iron complex of formula (I)
Fe(N(R)₂)₂ (I);
a solvent;
a cationizing agent; and
an alkylating agent,
wherein, in the formula (I), R symbols, which are identical or different, represent a hydrogen atom, a substituted or unsubstituted, linear or branched, C₁-C₂₀ aliphatic radical, a substituted or unsubstituted C₃-C₂₀ cycloaliphatic radical, a substituted or unsubstituted C₆-C₂₀ aromatic radical or a silyl radical of formula —Si(R′)₃ in which R′ symbols, which are identical or different, represent a hydrogen atom, a substituted or unsubstituted, linear or branched, C₁-C₂₀ aliphatic radical, a substituted or unsubstituted C₃-C₂₀ cycloaliphatic radical or a substituted or unsubstituted C₆-C₂₀ aromatic radical.

17. The catalytic system according to claim 16, wherein the R symbols, which are identical or different, represent a silyl radical of formula —Si(R′)₃ in which the R′ symbols, which are identical or different, represent a C₁-C₁₀ alkyl radical.

18. The catalytic system according to claim 16, wherein the solvent is a non-polar aliphatic solvent, a non-polar aromatic solvent or a mixture of a non-polar aliphatic solvent and a non-polar aromatic solvent.

19. The catalytic system according to claim 16, wherein the solvent is a non-polar aromatic solvent.

20. The catalytic system according to claim 16, wherein the solvent is a polar aprotic solvent selected from the group consisting of ethers, amines and mixtures thereof.

21. The catalytic system according to claim 16, wherein the alkylating agent is selected from the group consisting of alkylaluminums represented by formula (II):
(Ra)_{m′}Al(ORb)_{n′}H_{p′}X_{q′} (II),
in which:
Ra and Rb are identical or different and each represent a hydrocarbon group of 1 to 15 carbon atoms,
X is a halogen atom, and
m′, n′, p′ and q′ are numbers satisfying the following conditions:
0<m′≤3,
0≤n′<3,
0≤p′<3,
0≤q′<3 and
m′+n′+p′+q′=3.

22. The catalytic system according to claim 16, wherein the alkylating agent is selected from the group consisting of trialkylaluminum compounds of formula Al(C₁-C₁₀-alkyl)₃ and dialkylaluminium hydrides of formula Al(C₁-C₁₀-alkyl)₂H.

23. The catalytic system according to claim 16, wherein an alkylating agent/iron complex of formula (I) molar ratio is greater than or equal to 5/1.

24. The catalytic system according to claim 16, wherein the cationizing agent is selected from the group consisting of compounds represented by formula (III):
[Q]⁺[B(Ri)₄]⁻ (III),
in which:
[Q]⁺ is a proton, a carbonium cation, a substituted carbonium cation derivative, an ammonium cation, a substituted ammonium cation derivative, an oxonium cation, a substituted oxonium derivative, a phosphonium cation, a cycloheptyltrienyl cation, or a metallocenium cation of a transition metal,
B is boron, and
each Ri represents, independently of one another, a linear or branched C₁-C₂₀ aliphatic radical which is substituted or unsubstituted, a C₃-C₂₀ cycloaliphatic radical which is substituted or unsubstituted or a C₆-C₂₀ aromatic radical which is substituted or unsubstituted.

25. The catalytic system according to claim 16, wherein the cationizing agent is a trialkyl-substituted ammonium salt, an N,N-dialkylanilinium salt, a dialkylammonium salt or a trisubstituted carbonium salt.

26. The catalytic system according to claim 16, wherein a cationizing agent/iron complex of formula (I) molar ratio is less than or equal to 2/1.

27. A process for synthesis of a diene polymer comprising the step of:
polymerizing at least one conjugated diene monomer in a presence of the catalytic system according to claim 16.

28. The process according to claim 27, wherein the at least one conjugated diene monomer is butadiene, isoprene or a mixture of butadiene and of isoprene.
